(19) United States
(12) Patent Application Publication
(10) Pub. No.: US 2012/0161736 A1
(43) Pub. Date: Jun. 28, 2012

(54) APPARATUS AND METHOD FOR INITIALIZING DC-DC CONVERTER

(75) Inventors: Sewan Heo, Daejeon (KR); Yil Suk Yang, Daejeon (KR); JongDae Kim, Daejeon (KR)

(73) Assignee: ELECTRONICS AND TELECOMMUNICATIONS RESEARCH INSTITUTE, Daejeon (KR)

(21) Appl. No.: 13/311,582

(22) Filed: Dec. 6, 2011

(30) Foreign Application Priority Data
Dec. 23, 2010 (KR) 10-2010-0133902

(51) Int. Cl. G05F 1/46

(52) U.S. Cl. 323/284

(57) ABSTRACT

The present disclosure relates to an apparatus and method for initializing a DC-DC converter, and can stabilize an output voltage in an initial state, and prevent malfunction of a system control through initialization and high-efficiency DC-DC converters, by converting a variable voltage into a predetermined constant voltage and generating a reset signal for initializing a constant-voltage circuit so as to initialize the DC-DC converter and a control unit composed of the constant-voltage circuit, if the converted voltage reaches a target voltage, in an initialization DC-DC interval, and then converting the variable voltage into the predetermined constant voltage and outputting the converted voltage, in a high-efficiency DC-DC interval.

### CROSS-REFERENCE TO RELATED APPLICATIONS

This application is based on and claims priority from Korean Patent Application No. 10-2010-0133902, filed on Dec. 23, 2010, with the Korean Intellectual Property Office, the disclosure of which is incorporated herein in its entirety by reference.

### TECHNICAL FIELD

The present disclosure relates to an apparatus and method for initializing a DC-DC converter, and more particularly, to an apparatus and method for initializing a DC-DC converter which can stabilize an output voltage in an initial state and prevent malfunction of a system control through initialization and high-efficiency DC-DC converters. Specifically, the method converts a variable voltage to a predetermined constant voltage and generates a reset signal for initializing a constant-voltage circuit so as to initialize the DC-DC converter and a control unit composed of the constant-voltage circuit, if the converted voltage reaches a target voltage, in an initialization DC-DC interval. And, then the method converts the variable voltage to the predetermined constant voltage and outputs the converted voltage, in a high-efficiency DC-DC interval.

### BACKGROUND

DC-DC converters for converting a variable voltage power supply to a constant voltage and outputting the converted voltage are being widely used. The DC-DC converters convert various voltages to a constant voltage and output the constant voltage, and may be various types. Further, the DC-DC converters satisfy a current requirement amount of an output and constantly maintain an output voltage. The DC-DC converters include high-power, medium-power, and low-power converters, and have various kinds depending on the intended use. Furthermore, the DC-DC converters may have various configurations according to the relationship between a magnitude of an input voltage and a magnitude of an output voltage.

Recently, DC-DC converters may be installed in a system with various functions combined. In order to design a DC-DC converter having various functions, a DC-DC converter is required having various functions rather than a general simple configuration. For this reason, there are cases where a digital circuit or a processor for control controls a DC-DC converter.

In particular, there is a case where a circuit requiring a constant voltage is necessary in the process of designing a DC-DC converter. In this case, an input power supply having a variable voltage may not be used as it is. Moreover, the digital circuit or the processor for control may require a reset signal in order to perform an initialization operation.

In this case, the conventional DC-DC converter technology cannot stably initialize a DC-DC converter by using a variable voltage. Here, the system may have a complex configuration by systematizing circuits having various characteristics. In this case, the DC-DC converter may not be initialized and stably operated. This is because the system may not be operated by using the variable voltage directly as an input power supply. In view of the above, an initialization technology is needed for operating a DC-DC converter as soon as a variable voltage power supply is connected as an input power supply to the DC-DC converter.

### SUMMARY

The present disclosure has been made in an effort to provide an apparatus and method for initializing a DC-DC converter which can stabilize an output voltage in an initial state and prevent malfunction of a system control through initialization and high-efficiency DC-DC converters. Specifically, the method converts a variable voltage to a predetermined constant voltage and generates a reset signal for initializing a constant-voltage circuit so as to initialize the DC-DC converter and a control unit composed of the constant-voltage circuit, if the converted voltage reaches a target voltage, in an initialization DC-DC interval. And, then the method converts the variable voltage to the predetermined constant voltage and outputs the converted voltage, in a high-efficiency DC-DC interval.

An exemplary embodiment of the present disclosure provides an apparatus for initializing a DC-DC converter, including: a first voltage converting unit to receive a variable voltage, convert the variable voltage to generate a predetermined constant voltage, and output the converted voltage, in an initialization voltage conversion interval; a second voltage converting unit to receive the variable voltage, convert the variable voltage to the predetermined constant voltage and output the converted voltage when the predetermined constant voltage is received as a power source; a control unit to control the voltage conversion of the second voltage converting unit when the predetermined constant voltage is received as a power source; and a reset unit to compare an output voltage of the first voltage converting unit with a target voltage, and initialize and operate the control unit and the second voltage converting unit, and stop an operation of the first voltage converting unit if the output voltage of the first voltage converting unit reaches the target voltage.

Another exemplary embodiment of the present disclosure provides a method of initializing a DC-DC converter, including: a first converting step converting a variable voltage received as an input voltage into a predetermined constant voltage, and outputting the converted voltage as an output voltage in an initialization voltage conversion interval; comparing the output voltage output at the first converting step with a target voltage; initializing the DC-DC converter when the output voltage output at the first converting step reaches the target voltage; a second converting step converting the variable voltage into the predetermined constant voltage through the initialized DC-DC converter, and outputting the converted voltage through the initialized DC-DC converter; and supplying the constant voltage output at the second converting step as a power source.

According to the exemplary embodiments of the present disclosure, it is possible to stabilize an output voltage in an initial state and prevent malfunction of a system control through initialization and high-efficiency DC-DC converters, by converting a variable voltage to a predetermined constant voltage and generating a reset signal for initializing a constant-voltage circuit so as to initialize the DC-DC converter and a control unit composed of the constant-voltage circuit, if the converted voltage reaches a target voltage, in an initialization DC-DC interval, and then converting the variable voltage to the predetermined constant voltage and outputting the converted voltage, in a high-efficiency DC-DC interval.

Further, according to the exemplary embodiments of the present disclosure, in the case where the control unit composed of a constant-voltage circuit controls another system, it is possible to supply a predetermined constant voltage in order to prevent the system from malfunctioning and to supply a constant voltage to a combined circuit, which includes a DC-DC converter and has various functions, so as to stably operate the system even in the initial state.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating the configuration of an apparatus for initializing a DC-DC converter, according to an exemplary embodiment of the present disclosure.

FIG. 2 is an explanatory diagram illustrating the process of initializing two output voltages in a DC-DC converter, according to an exemplary embodiment of the present disclosure.

FIG. 3 is a flow chart illustrating the method of initializing a DC-DC converter, according to an exemplary embodiment of the present disclosure.

### DETAILED DESCRIPTION

In the following detailed description, reference is made to the accompanying drawings, which form a part hereof. The illustrative embodiments described in the detailed description, drawing, and claims are not meant to be limiting. Other embodiments may be utilized, and other changes may be made, without departing from the spirit or scope of the subject matter presented here. Also, prior to describe particularly the present disclosure, it is to be understood that like numerals represent like constitutional elements throughout the accompanying drawings, and the detailed description relating to the known technical constitution will be omitted in order to unnecessarily obscure the gist of the present disclosure.

Exemplary embodiments of the present disclosure relate to an apparatus and method for initializing a DC-DC converter which can stabilize a system operation through a reset signal for initializing an output voltage by using an initialization DC-DC converter because a variable input power supply cannot be used as it is when a high-efficiency DC-DC converter and a control unit are composed of a constant-voltage circuit. That is, for a high-efficiency DC-DC converter and a control unit composed of a constant-voltage circuit, the exemplary embodiments of the present disclosure can connect an initialization DC-DC converter for initialization of an output voltage to the high-efficiency DC-DC converter in parallel, thereby stabilizing an output voltage and preventing malfunction of a system control through a reset signal in an initial state.

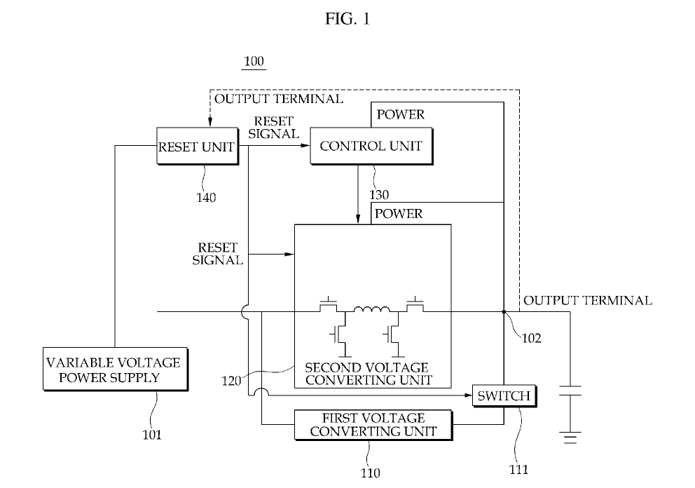

FIG. 1 is a diagram illustrating the configuration of an apparatus for initializing a DC-DC converter, according to an exemplary embodiment of the present disclosure.

As shown in FIG. 1, an initialization apparatus 100 for initializing a DC-DC converter according to an exemplary embodiment of the present disclosure includes a first voltage converting unit 110, a second voltage converting unit 120, a control unit 130, and a reset unit 140. Here, second voltage converting unit 120 may include a constant-voltage circuit, a plurality of transistors, and inductors. First voltage converting unit 110, second voltage converting unit 120, and reset unit 140 are connected to a variable voltage power supply 101 and receive a variable voltage from variable voltage power supply 101. First voltage converting unit 110, second voltage converting unit 120, and control unit 130 are connected to an output terminal 102. Output terminal 102 is connected to first voltage converting unit 110 through a switch 111 and is connected to a ground through a capacitor.

Hereinafter, each of the components of initialization apparatus 100 for initializing a DC-DC converter according to the exemplary embodiment of the present disclosure will be described.

First voltage converting unit 110 converts the variable voltage to generate a predetermined constant voltage from the variable voltage input from variable voltage power supply 101, and outputs the converted voltage to output terminal 102. That is, if the variable voltage input from variable voltage power supply 101 is lower than the predetermined constant voltage, first voltage converting unit 110 processes the variable voltage to increase the variable voltage. In contrast, if the variable voltage input from variable voltage power supply 101 is equal to or higher than the predetermined constant voltage, first voltage converting unit 110 processes the variable voltage to decrease the variable voltage. First voltage converting unit 110 is connected to second voltage converting unit 120 in parallel, and is connected to output terminal 102 through switch 111 composed of a transistor. First voltage converting unit 110 stabilizes an output voltage in an initial DC-DC state on behalf of second voltage converting unit 120. During the initial state in which the predetermined constant voltage has not yet been formed, first voltage converting unit 110 converts the variable voltage input from variable voltage power supply 101 to output a constant output voltage. That is, first voltage converting unit 110 receives the variable voltage from variable voltage power supply 101 and generates the constant output voltage. At this time, first voltage converting unit 110 generates the output voltage by converting the variable voltage into the predetermined constant voltage in the initial state where the output voltage has not become the predetermined constant voltage. In this case, first voltage converting unit 110 can increase or decrease the variable voltage to the predetermined constant voltage. Here, the predetermined constant voltage indicates a stabilized voltage capable of operating control unit 130 or second voltage converting unit 120 composed of a constant-voltage circuit.

Second voltage converting unit 120 is composed of a constant-voltage circuit and receives the predetermined constant voltage as a power source. Second voltage converting unit 120 does not operate in the initial state in which the output voltage of output terminal 102 has not been stabilized. Since second voltage converting unit 120 is composed of the constant-voltage circuit using the output voltage as a power source, second voltage converting unit 120 does not normally operate in the initial state. Further, second voltage converting unit 120 receives the variable voltage from variable voltage power supply 101, converts the variable voltage into the predetermined constant voltage in a high-efficiency DC-DC interval, and outputs the converted voltage to output terminal 102. Here, second voltage converting unit 120 converts the variable voltage into the predetermined constant voltage with a switching mode power supply (SMPS) method. Here, the switching mode power supply method is a high-efficiency DC-DC converting method, and is used to output the predetermined constant voltage from variable voltage power supply 101 at a high efficiency. That is, second voltage converting unit 120 can convert a voltage at a high efficiency by using a SMPS-type high-efficiency DC-DC converter 120.

Control unit 130 controls second voltage converting unit 120 composed of the constant-voltage circuit. Control unit 130 can control second voltage converting unit 120 to control the voltage converting process performed in second voltage converting unit 120. Control unit 130 receives a constant voltage as a power source to control the operation of a system including second voltage converting unit 120, and the operation of control unit 130 is initialized by a reset signal. Reset unit 140 initializes control unit 130 according to an initialization algorithm. Control unit 130 receives the predetermined constant voltage output from second voltage converting unit 120 as a power source. Control unit 130 can control second voltage converting unit 120 when the predetermined constant voltage is received as a power source.

That is, control unit 130 is formed with the constant-voltage circuit initialized by the reset signal and requires the predetermined constant voltage for the system control. Here, the predetermined constant voltage can be stably obtained at a high efficiency only through second voltage converting unit 120. Since second voltage converting unit 120 is not controlled by control unit 130 in the initial DC-DC state, second voltage converting unit 120 may be malfunctioning. First voltage converting unit 110 can be operated only by the variable voltage in the initial state in which control unit 130 requiring the predetermined constant voltage is not operated.

Reset unit 140 compares the output voltage of first voltage converting unit 110 with a target voltage. When the output voltage reaches the target voltage, reset unit 140 initializes control unit 130 and second voltage converting unit 120, and stops the operation of first voltage converting unit 110. Here, the target voltage is a voltage obtained by subtracting a tolerance from the predetermined constant voltage, and can be the predetermined constant voltage in the case where the tolerance is ‘0’. That is, if the output voltage of first voltage converting unit 110 reaches the target voltage, reset unit 140 generates the reset signal for initializing control unit 130 and second voltage converting unit 120. That is, for control unit 130 and second voltage converting unit 120 requiring the predetermined constant voltage as a power source, reset unit 140 monitors the output voltage and generates the reset signal if the target voltage is output. In the case of monitoring a plurality of output voltages, when all of the output voltages to be used as a power source reaches individual target voltages, reset unit 140 generates the reset signal.

Then, reset unit 140 outputs the generated reset signal to control unit 130 and second voltage converting unit 120 composed of the constant-voltage circuit, so as to initialize control unit 130 and second voltage converting unit 120 by the generated reset signal. Each of control unit 130 and second voltage converting unit 120 is initialized by the reset signal. In order for second voltage converting unit 120 to be normally operated, control unit 130 composed of the constant-voltage circuit and an internal constant-voltage circuit need to be initialized and normally operated. Moreover, reset unit 140 operates second voltage converting unit 120 to maintain the output voltage. Also, reset unit 140 short-circuits switch 111 connected to first voltage converting unit 110. When switch 111 is short-circuited, first voltage converting unit 110 is disconnected from output terminal 102. Therefore, control unit 130 and second voltage converting unit 120 are being operated again under the power of the predetermined constant voltage, and thus, malfunction does not occur. Reset unit 140 maintains the generated reset signal during a predetermined interval, and then short-circuits switch 111 connected to first voltage converting unit 110.

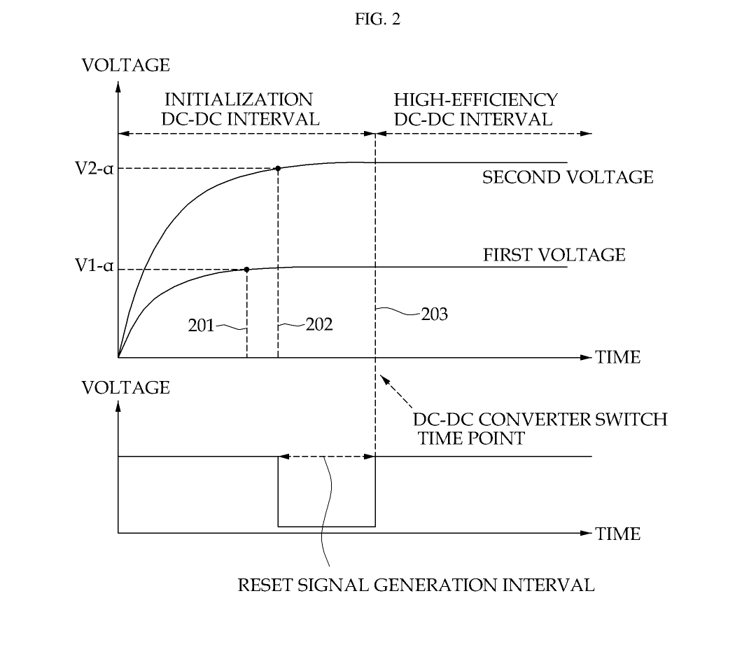

FIG. 2 is an explanatory diagram illustrating the process of initializing two output voltages in an apparatus for initializing a DC-DC converter, according to an exemplary embodiment of the present disclosure.

Reset unit 140 compares two output voltages with target voltages each set for the individual output voltage. If the two output voltages reach the target voltages, reset unit 140 initializes and operates control unit 130 as well as second voltage converting unit 120. Here, the output voltages indicates voltages output through output terminal 102. Also, reset unit 140 stops the operation of first voltage converting unit 110.

As an example, a case where second voltage converting unit 120 outputs two output voltages will be described below. In the case of outputting two output voltages, second voltage converting unit 120 is composed of two DC-DC converters. In FIG. 2, there is shown a DC-DC converter switch time point 203 from first voltage converting unit 110 to second voltage converting unit 120 in the case where each output voltage is used as a power source for control unit 130 and second voltage converting unit 120.

Second voltage converting unit 120 outputs two output voltages. First voltage converting unit 110 increases output voltages to predetermined constant voltages in the initialization DC-DC interval in which two voltages for an operation of second voltage converting unit 120 have not yet been formed. When each of the individual output voltage is referred to as a first voltage and a second voltage, respectively, and the predetermined constant voltages are denoted by V1 and V2, first voltage converting unit 110 gradually increases the first voltage and the second voltage to the predetermined constant voltages V1 and V2. The first voltage reaches a target voltage V1-α obtained by subtracting a tolerance from the predetermined constant voltage at a time point 201, and the second voltage reaches a target voltage V2-α obtained by subtracting the tolerance from the predetermined constant voltage at a time point 202. Here, α denotes the tolerance.

After all of the first and second voltages reach the target voltages and a reset signal generation interval is passed, reset unit 140 determines that a constant voltage has been generated sufficient to be used as a power source. Here, in the case of the tolerance of ‘α’, the reset signal generating time point may be a time point where both of the first voltage and the second voltage reach V1-α and V2-α, respectively. At this time point, it can be considered that each of the first voltage and the second voltage has been reached the respective target voltage. Therefore, reset unit 140 generates the reset signal at the time point 202. After the reset signal generation interval is passed and the reset signal is disappeared, reset unit 140 turns off switch 111 between output terminal 102 and first voltage converting unit 110 so as to switch the DC-DC converter from first voltage converting unit 110 to second voltage converting unit 120. Then, the first voltage and the second voltage are maintained at the target voltages V1 and V2, respectively.

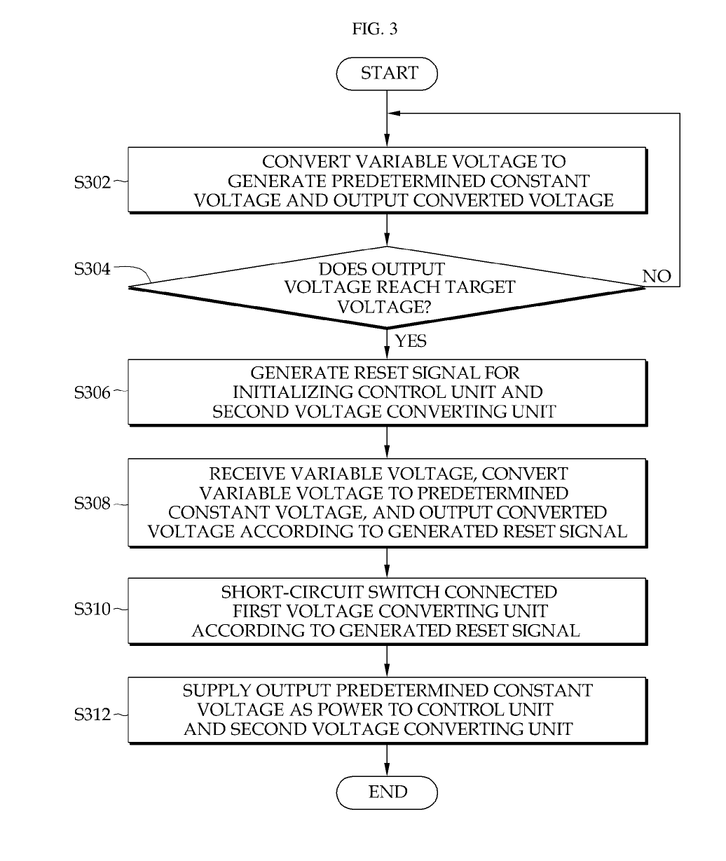

FIG. 3 is a flow chart illustrating the method of initializing a DC-DC converter, according to an exemplary embodiment of the present disclosure.

If variable voltage power supply 101 is connected to apparatus 100 for initializing a DC-DC converter, second voltage converting unit 120 does not operate and first voltage converting unit 110 receives the variable voltage from variable voltage power supply 101 in the initial state.

First voltage converting unit 110 receives the variable voltage from variable voltage power supply 101, converts the variable voltage to generate the predetermined constant voltage, and outputs the output voltage (S302).

Then, reset unit 140 compares the output voltage output from output terminal 102 with the target voltage to check whether the output voltage has reached the target voltage (S304).

If it is determined that the output voltage has reached the target voltage as the result of the check (S304), reset unit 140 generates the reset signal for initializing control unit 130 and second voltage converting unit 120 (S306). In contrast, if it is determined that the output voltage has not yet reached the target voltage as the result of the check (S304), first voltage converting unit 110 performs the procedure from the step (S302) again, and reset unit 140 monitors whether the output voltage has reached the target voltage.

After the reset signal is generated, according to the generated reset signal, second voltage converting unit 120 receives the variable voltage, converts the variable voltage into the predetermined constant voltage, and outputs the converted voltage (S308). If the output voltage reaches the predetermined constant voltage, in the step S304, the reset signal is generated, and thus, control unit 130 and second voltage converting unit 120 are initialized. If the reset signal is completed, the DC-DC converter is switched from first voltage converting unit 110 to second voltage converting unit 120. Second voltage converting unit 120 receives the variable voltage and outputs the predetermined constant voltage. Then, second voltage converting unit 120 can maintain the output voltage at the predetermined constant voltage. Second voltage converting unit 120 converts the variable voltage into the predetermined constant voltage by using the switching mode power supply method and outputs the converted voltage.

Then, reset unit 140 short-circuits switch 111 connected to first voltage converting unit 110 according to the generated reset signal (S310). After maintaining the generated reset signal during the predetermined interval, reset unit 140 short-circuits switch 111 connected to first voltage converting unit 110.

Next, second voltage converting unit 120 supplies the predetermined constant voltage as a power source to control unit 130 and second voltage converting unit 120 (S312).

Meanwhile, if second voltage converting unit 120 outputs a plurality of output voltages and the plurality of output voltages reach target voltages set for each output voltage, reset unit 140 performs the step (S308) of receiving the variable voltage, converting the variable voltage into the predetermined constant voltage, and outputting the converted voltage, and stops the step (S302) of converting the variable voltage into the predetermined constant voltage.

According to the exemplary embodiments of the present disclosure, it is possible to stabilize the output voltage in an initial state and prevent malfunction of a system control through initialization and high-efficiency DC-DC converters, by converting a variable voltage into a predetermined constant voltage and generating a reset signal for initializing a constant-voltage circuit so as to initialize the DC-DC converter and a control unit composed of the constant-voltage circuit, if the converted voltage reaches a target voltage, in an initialization DC-DC interval, and then converting the variable voltage into the predetermined constant voltage and outputting the converted voltage, in a high-efficiency DC-DC interval.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus for initializing a DC-DC converter, comprising:
a first voltage converting unit configured to receive a variable voltage, convert the variable voltage to generate a predetermined constant voltage, and output the converted voltage in an initialization voltage conversion interval;
a second voltage converting unit configured to receive the variable voltage, convert the variable voltage into the predetermined constant voltage, and output the converted voltage in the case of receiving the predetermined constant voltage as a power source;
a control unit configured to control voltage conversion of the second voltage converting unit in the case of receiving the predetermined constant voltage as a power source; and
a reset unit configured to compare an output voltage of the first voltage converting unit with a target voltage, and initialize and operate the control unit and the second voltage converting unit, and stop an operation of the first voltage converting unit, if the output voltage of the first voltage converting unit reaches the target voltage.

2. The apparatus of claim 1, wherein the second voltage converting unit converts the input variable voltage into the predetermined constant voltage by using a switching mode power supply method.

3. The apparatus of claim 1, wherein the control unit controls voltage conversion of the second voltage converting unit and operates second voltage converting unit in the case of receiving the predetermined constant voltage as a power source.

4. The apparatus of claim 1, wherein the first voltage converting unit is connected to the second voltage converting unit in parallel through a switch of an output terminal.

5. The apparatus of claim 4, wherein if the output voltage of the first voltage converting unit reaches the target voltage, the reset unit generates a reset signal for initializing the control unit and the second voltage converting unit, and then operates the control unit and the second voltage converting unit, and short-circuits the switch connected to the first voltage converting unit.

6. The apparatus of claim 4, wherein if the target voltage is a voltage obtained by subtracting a tolerance from the predetermined constant voltage, the reset unit maintains the generated reset signal during a reset signal generation interval, and then operates the control unit and the second voltage converting unit, and short-circuits the switch connected to the first voltage converting unit.

7. The apparatus of claim 1, wherein if the first voltage converting unit outputs a plurality of output voltages and the plurality of output voltages reach target voltages set for each output voltage, the reset unit operates the control unit and the second voltage converting unit, and stops the first voltage converting unit.

8. A method of initializing a DC-DC converter, comprising:
a first converting step converting a variable voltage received as an input voltage into a predetermined constant voltage, and outputting the converted voltage as an output voltage in an initialization voltage conversion interval;
comparing the output voltage output at the first converting step with a target voltage;
initializing the DC-DC converter when the output voltage output at the first converting step reaches the target voltage;
a second converting step converting the variable voltage into the predetermined constant voltage through the initialized DC-DC converter, and outputting the converted voltage through the initialized DC-DC converter; and
supplying the constant voltage output at the second converting step as a power source.

9. The method of claim 8, wherein the second converting step utilizes a switching mode power supply method to convert the received variable voltage into the predetermined constant voltage.

10. The method of claim 8, wherein the second converting step includes:
generating a reset signal for the initialization when the output voltage output at the first converting step reaches the target voltage;
converting the variable voltage into the predetermined constant voltage, and outputting the converted voltage, according to the generated reset signal; and
short-circuiting a switch according to the generated reset signal.

11. The method of claim 10, wherein if the target voltage corresponds to a voltage obtained by subtracting a tolerance from the predetermined constant voltage, the generated reset signal is maintained during a reset signal generation interval in the reset signal generation, and then voltage conversion and the switch short-circuiting are performed.

12. The method of claim 8, wherein if a plurality of output voltages are output in the first voltage conversion and the plurality of output voltages are equal to or higher than target voltages set for each output voltage, the second voltage conversion is performed but the first voltage conversion stops.
